(19) United States
(12) Patent Application Publication
(10) Pub. No.: US 2015/0242426 A1
(43) Pub. Date: Aug. 27, 2015

(54) INFORMATION PROCESSING SYSTEM, INFORMATION PROCESSING METHOD, AND NON-TRANSITORY COMPUTER READABLE MEDIUM

(71) Applicant: FUJI XEROX CO., LTD., Tokyo (JP)

(72) Inventor: Taro TERAO, Kanagawa (JP)

(73) Assignee: FUJI XEROX CO., LTD., Minato-ku, Tokyo (JP)

(21) Appl. No.: 14/478,623

(22) Filed: Sep. 5, 2014

(30) Foreign Application Priority Data
Feb. 27, 2014 (JP) 2014-036503
Feb. 27, 2014 (JP) 2014-036504

(51) Int. Cl. G06F 17/30

(52) U.S. Cl. CPC G06F 17/30091; G06F 17/30864; G06F 17/30339

(57) ABSTRACT

An information processing system includes a managing unit that manages objects for each of which at least one of a parent and a child is defined, an element name and an element value of an element composing content being associated with at least part of the objects in the managing unit; a receiving unit that receives a request for a process including specification of an authorized object with which authority information is associated; a setting unit that sets a target object on the basis of the authorized object and, if the element name specified in the request is not associated with the target object, repeats a process of setting a parent object of the target object as a new target object until a predetermined condition is met; and a responding unit that otherwise returns the element value associated with the target object as a response to the request.

### CROSS-REFERENCE TO RELATED APPLICATIONS

This application is based on and claims priority under 35 USC 119 from Japanese Patent Application No. 2014-036503 filed Feb. 27, 2014 and Japanese Patent Application No. 2014-036504 filed Feb. 27, 2014.

### BACKGROUND

(i) Technical Field

The present invention relates to an information processing system, an information processing method, and a non-transitory computer readable medium.

(ii) Related Art

Servers managing objects may process (for example, generate, acquire, change, or delete) the objects depending on authorities of clients, which submit requests for the processing. Since the objects managed by the servers may be subjected to, for example, the generation, the change, or the deletion, fixing the authorities to the clients independently of the objects may make difficult to flexibly process the objects in accordance with the authorities of the clients. In addition, allowing the content of content to be provided to be varied depending on the authorities of the clients may advance the development of systems and may improve the availability of the systems.

### SUMMARY

According to an aspect of the invention, there is provided an information processing system including a managing unit that manages objects for each of which at least one of a parent and a child is defined, an element name and an element value of an element composing content being associated with at least part of the objects in the managing unit; a receiving unit that receives a request for a process including specification of an authorized object with which authority information is associated; a setting unit that sets a target object on the basis of the authorized object and, if the element name specified in the request is not associated with the target object, repeats a process of setting a parent object of the target object as a new target object until a predetermined condition is met; and a responding unit that, if the element name specified in the request is associated with the target object set by the setting unit, returns the element value associated with the target object as a response to the request.

### BRIEF DESCRIPTION OF THE DRAWINGS

Exemplary embodiments of the present invention will be described in detail based on the following figures, wherein:

FIG. 1 illustrates an exemplary configuration of an information processing system according to an exemplary embodiment;

FIG. 2 is a functional block diagram of an information managing apparatus;

FIGS. 3A to 3C illustrate exemplary data structures of objects;

FIG. 4 illustrates an exemplary prototype-based object management table;

FIG. 5 illustrates an exemplary value management table;

FIG. 6 illustrates an exemplary data object management table;

FIG. 7 is a flowchart illustrating an exemplary process of generating an access token;

FIG. 8 is a flowchart illustrating an exemplary process for a request received from a user terminal;

FIG. 9 is a flowchart illustrating an exemplary verification process of the access token;

FIG. 10 is a flowchart illustrating an exemplary process for a data acquisition request received from the user terminal;

FIG. 11 illustrates an exemplary tree structure composed of prototype-based objects; and

FIG. 12 illustrates exemplary pieces of data added to the objects.

### DETAILED DESCRIPTION

Exemplary embodiments of the present invention will herein be described with reference to the attached drawings.

### [1. Description of System Configuration]

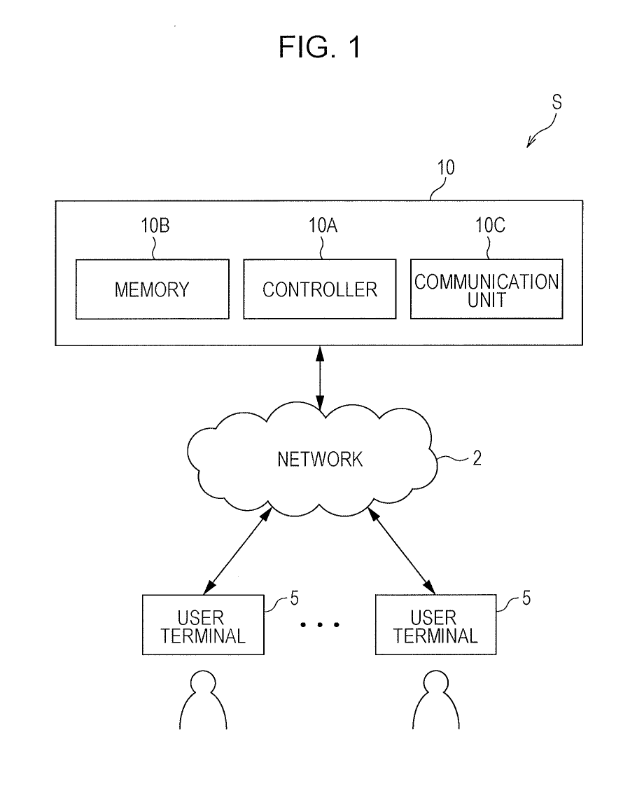

FIG. 1 illustrates an exemplary configuration of an information processing system S according to an exemplary embodiment. Referring to FIG. 1, the information processing system S includes an information managing apparatus 10 and one or more user terminals 5. The information managing apparatus 10 and the one or more user terminals 5 are connected to each other via a network 2 so as to be capable of data communication.

As illustrated in FIG. 1, the information managing apparatus 10 includes a controller 10A, a memory 10B, and a communication unit 10C as an exemplary hardware configuration.

The controller 10A includes a central processing unit (CPU). The controller 10A executes a variety of arithmetic processing and controls each component in the information managing apparatus 10 on the basis of programs stored in the memory 10B.

The memory 10B stores control programs, such as an operating system (OS) of the information managing apparatus 10, and data and is also used as a working memory of the controller 10A. The programs may be supplied to the information managing apparatus 10 in a state in which the programs are stored in an information storage medium, such as an optical disk, a magnetic disk, a magnetic tape, a magneto-optical disk, or a flash memory, or may be supplied to the information managing apparatus 10 over a data communication network, such as the Internet.

The communication unit 10C includes, for example, a network interface card (NIC) and is connected to the network 2 via the NIC to communicate with the one or more user terminals 5 connected to the network 2.

In the present exemplary embodiment, the information managing apparatus 10 manages prototype-based objects. The prototype-based objects are objects each having only one parent object (prototype), except for a root object existing alone in a collection of the prototype-based objects. The root object does not have its prototype. When an object A is the prototype of an object B, the object B is also referred to as an artifact of the object A. The entire collection of the prototype-based objects is represented by a tree structure using the prototype relationship between the objects. Reconnecting the prototypes allows the tree structure to be modified as long as the reconnection does not destroy the tree structure composed of the objects. The objects managed by the information managing apparatus 10 may have attributes and attribute values. In a REpresentational State Transfer (REST) architecture style, each object may be called a resource and each value may be called a representation. The object having the value may represent authority information called access token. The objects may include objects representing only simple identities simply composed of object identifiers and the prototypes, objects representing pieces of data having arbitrary content-type values, and objects representing entities, such as the access token, which is a credential certifying the access qualification; resource owners, which are the owners of the objects; or applications (clients), which access the objects on the basis of the approval of the resource owners. These objects are included in one tree structure.

In the present exemplary embodiment, the information managing apparatus 10 performs addition or update of the object to be managed, reading or deletion of information, and so on in accordance with a request received from the user terminal 5. In addition, the information managing apparatus 10 associates identification information for identifying a function with an authorized object called the access token to process the request received from the user terminal 5 with the function associated with the authorized object received from the user terminal 5 along with the request. Exemplary functions with which the information managing apparatus 10 is provided in order to realize the above processing will be described in detail below.

### [2. Description of Functions of Information Managing Apparatus 10]

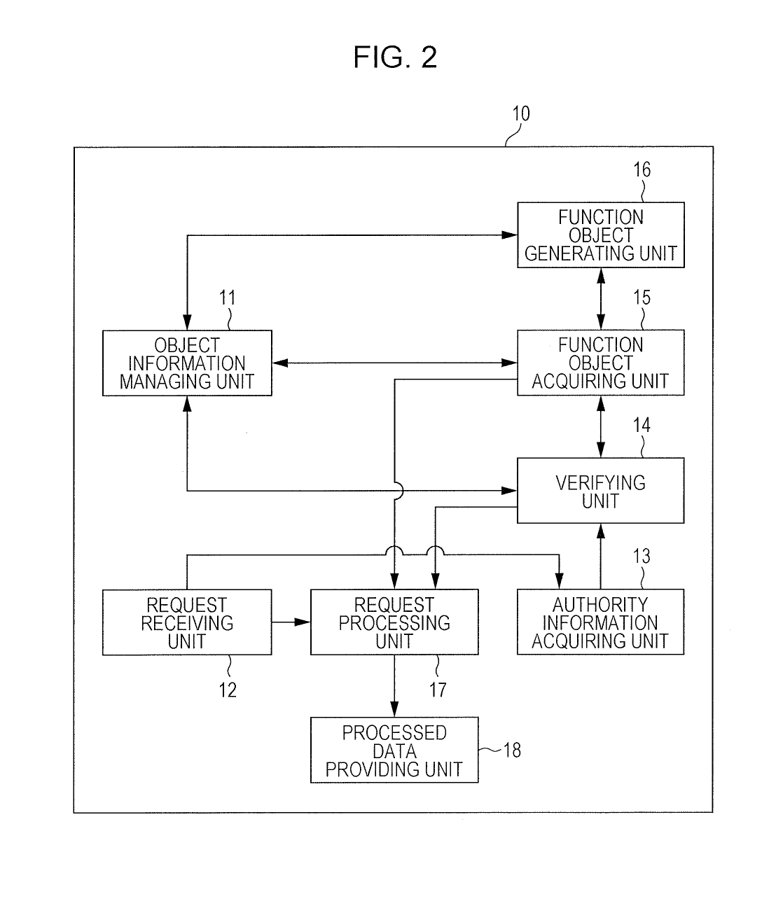

Exemplary functions of the information managing apparatus 10 will now be described with reference to a functional block diagram of the information managing apparatus 10 illustrated in FIG. 2. Referring to FIG. 2, the information managing apparatus 10 includes an object information managing unit 11, a request receiving unit 12, an authority information acquiring unit 13, a verifying unit 14, a function object acquiring unit 15, a function object generating unit 16, a request processing unit 17, and a processed data providing unit 18.

The function of each component provided in the information managing apparatus 10 may be realized by the controller 10A in the information managing apparatus 10, which reads out the programs stored in the memory 10B or the computer-readable information storage medium to execute the programs that are read out. The programs may be supplied to the information managing apparatus 10 via an information storage medium, such as an optical disk, a magnetic disk, a magnetic tape, a magneto-optical disk, or a flash memory, or may be supplied to the information managing apparatus 10 over a data communication network, such as the Internet. The function of each component in the information managing apparatus 10 will now be described in detail.

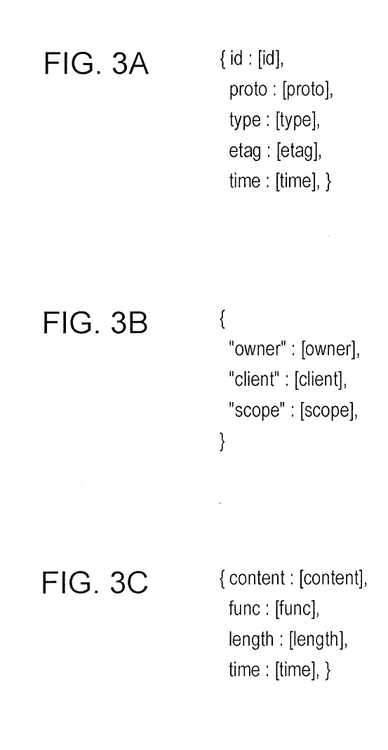

The object information managing unit 11 manages information about the prototype-based objects and information about data objects. The prototype-based objects include the authorized objects called the access token, with which the authority information is associated. The prototype-based objects are mutable objects and are typically identified with identifiers (IDs) that are generated at random. The data objects are immutable objects and are typically identified with IDs that are calculated as hash values of the corresponding pieces of data. The data objects include, for example, source codes used for generating function objects and function data objects including the identification information about the function objects generated from the source codes and so on. Exemplary data structures of the prototype-based object and the data object will now be described with reference to FIG. 3A to FIG. 3C. In the examples illustrated in FIG. 3A to FIG. 3C, the specific content of each element composing the data is represented by [element].

FIG. 3A illustrates an exemplary basic data structure of the prototype-based object. As illustrated in FIG. 3A, the prototype-based object includes “id” which is the identification information about the object, “proto” which is the identification information about the parent (prototype) object of the object, “type” indicating the type of the object, “etag” representing the identification information about the data object in which the content of data of the object is stored, and “time” representing the date and time when the object is generated. The data structure of the prototype-based object is not limited to the one illustrated in FIG. 3A and may include elements other than the above elements as long as “id” and “proto” are included.

FIG. 3B illustrates an exemplary data structure of the access token. As illustrated in FIG. 3B, the access token includes information including {“owner”:object ID of owner, “client”:object ID of client, and “scope”:identification information for identifying the function}. In the information processing system S according to the present exemplary embodiment, the access token is added to the processing request received from the user terminal 5. Here, the owner is processed as a requestor of the processing, the client is processed as a proxy requestor of the processing, and the identification information about the function data object is stored in the scope.

FIG. 3C illustrates an exemplary data structure of the data object (function data object). As illustrated in FIG. 3C, the function data object includes “content” in which the source code (script) is stored, “func” which is the identification information about the function object generated (evaluated) from the source code (script), “length” representing the octet length of the content of data, and “time” indicating the date and time when the data is registered. The structure of the data object is not limited to the one illustrated in FIG. 3C. For example, a list of clients that have accessed the data may be stored in the data object. In this case, the list of all the clients that have accessed a specific octet array may be created.

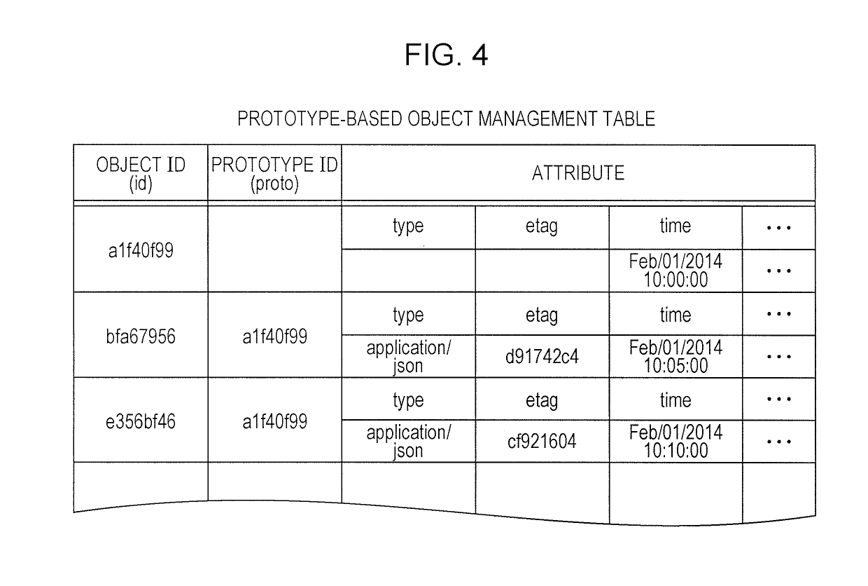

Exemplary management tables used for managing the prototype-based object and the data object having the data structures illustrated in FIG. 3A to FIG. 3C will now be described with reference to FIG. 4 to FIG. 6.

FIG. 4 illustrates an exemplary prototype-based object management table used for managing the information about the prototype-based objects. As illustrated in FIG. 4, an object ID for identifying each object, a prototype ID for identifying the prototype object which is the parent (prototype) of the object, and attribute information about the object are stored in the prototype-based object management table in association with each other. For example, the attribute information about the object includes the type information (“type”) about the object, the identification information (“etag”) about the data (object) in which the value stored in (associated with) the object is stored, and the date and time (“time”) when the object is generated, and so on.

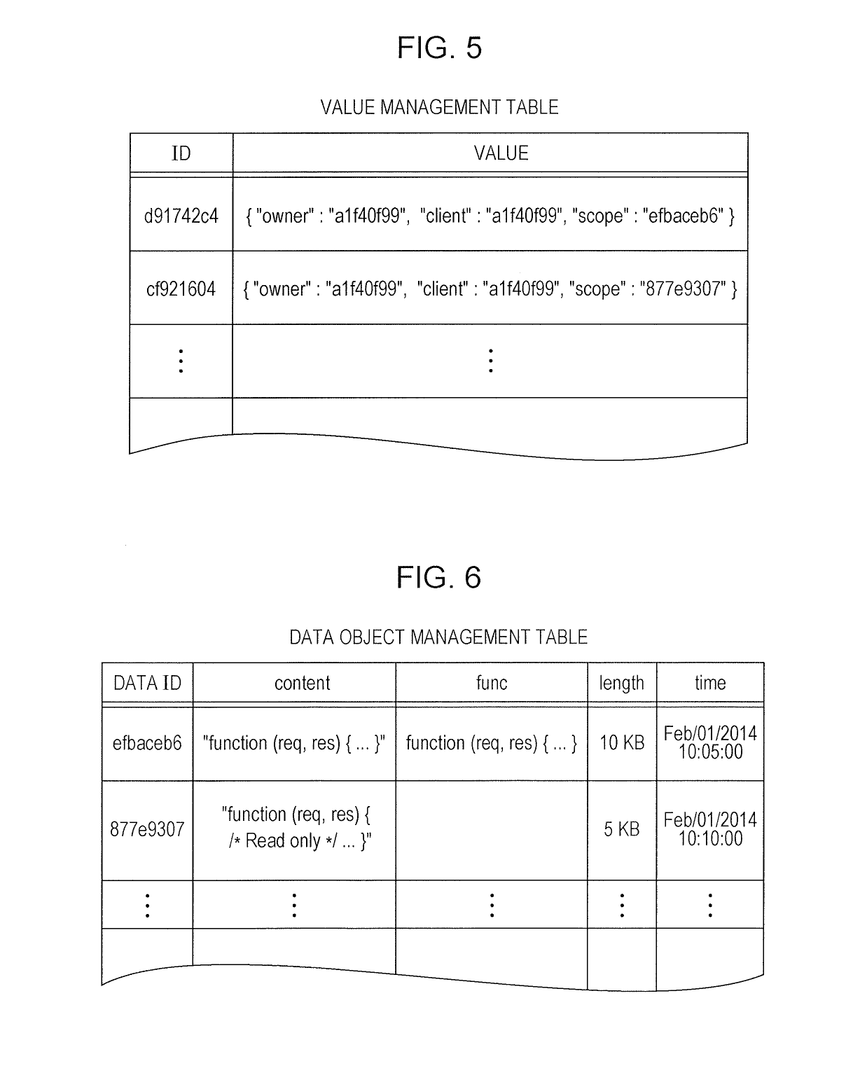

FIG. 5 illustrates an exemplary value management table in which the data corresponding to “etag” of the prototype-based object is stored. As illustrated in FIG. 5, the information about the value is stored in the value management table in association with each ID (key) of “etag.” For example, in the case of the access token, the value is described in an application/json type data format {“owner”:object ID of owner, “client”:object ID of client, “scope”:identification information for identifying the function}.

FIG. 6 illustrates an exemplary data object management table used for managing information about the data object (the function data object here). As illustrated in FIG. 6, a data ID for identifying each data object, “content” in which the source code (script) of the function object is stored, “func” which is the identification information about the function object generated by evaluating the source code, “length” representing the octet length of the content of data, and “time” indicating the date and time when the data is registered are stored in the data object management table in association with each other.

The request receiving unit 12 receives a request concerning the processing of the object managed by the object information managing unit 11 from the user terminal 5. For example, the request receiving unit 12 may receive the request in a HyperText Transfer Protocol (HTTP) format from the user terminal 5.

The authority information acquiring unit 13 acquires information about the access token (authorized object) concerning the request received by the request receiving unit 12. For example, the authority information acquiring unit 13 may acquire the information about the access token from an Authorization field in the HTTP request or may acquire the information about the access token from any cookie including the information about the access token.

The verifying unit 14 verifies whether the information about the access token (authorized object) acquired by the authority information acquiring unit 13 is valid. A specific example of the verification process in the verifying unit 14 will now be described.

First, the verifying unit 14 determines whether the ID of the access token acquired by the authority information acquiring unit 13 is included in the prototype-based object management table managed by the object information managing unit 11 (a first condition). If the ID of the access token is not included in the prototype-based object management table, the verifying unit 14 determines that the verification failed.

If the first condition is met, the verifying unit 14 determines whether the data format (type) of the access token is a certain type (that is, application/json) (a second condition). If the data format (type) of the access token is not the certain type, the verifying unit 14 determines that the verification failed.

If the second condition is met, the verifying unit 14 acquires the values of the access token (the values of “owner”, “client”, and “scope”) to determine whether the respective values of “owner”, “client”, and “scope” are the data managed by the object information managing unit 11 (a third condition). If any of the values is not the data managed by the object information managing unit 11, the verifying unit 14 determines that the verification failed.

If the third condition is met, the verifying unit 14 acquires the information about the prototype of the access token from the object information managing unit 11 to determine whether the prototype of the access token coincides with the owner of the access token or is included in a prototype chain of the owner (a path in which ancestors of the owner are connected sequentially from the parent of the owner) (a fourth condition). If the prototype of the access token does not coincide with the owner of the access token and is not included in the prototype chain, the verifying unit 14 determines that the verification failed.

If the fourth condition is met, the verifying unit 14 determines whether the function object is allocated to the information about the scope of the access token (a fifth condition). If no function object is allocated to the scope, the verifying unit 14 determines that the verification failed. If the function object is allocated to the scope, the verifying unit 14 determines that the verification succeeded. Whether the function object is allocated to the scope may be based on whether the function object is acquired by the function object acquiring unit 15 on the basis of the information about the scope.

The function object acquiring unit 15 acquires the information about the function object associated with the scope from the object information managing unit 11 on the basis of the information about the scope of the access token. For example, the function object acquiring unit 15 searches the data object management table managed by the object information managing unit 11 for the corresponding record on the basis of the information about the scope of the access token (the ID of the data object). The function object acquiring unit 15 refers to the func attribute of the record that is searched for and, if a value is stored in the func attribute, the function object acquiring unit 15 acquires the value of the func attribute as the identification information about the function object. If no value is stored in the func attribute of the record that is searched for, the function object acquiring unit 15 requests the function object generating unit 16 to generate (evaluate) the function object based on the source code stored in the content attribute.

The function object generating unit 16 determines whether the source code concerning the request from the function object generating unit 16 is capable of being evaluated as the function. If the source code is not capable of being evaluated as the function, the function object generating unit 16 returns an error to the function object acquiring unit 15. If the source code is capable of being evaluated as the function, the function object generating unit 16 returns the identification information of the function object generated on the basis of the source code to the function object acquiring unit 15.

If the error is returned from the function object generating unit 16, the function object acquiring unit 15 indicates that the function object is not allocated to the verifying unit 14. If the identification information about the function object is returned from the function object generating unit 16, the function object acquiring unit 15 stores the identification information about the function object as the value of the func attribute of the corresponding record and indicates the identification information about the function object allocated to the scope to the verifying unit 14.

The request processing unit 17 controls the processing of the request received by the request receiving unit 12 on the basis of the result of the verification of the access token (authorized object) acquired by the authority information acquiring unit 13 for the request received by the request receiving unit 12, which is indicated from the verifying unit 14, and the function object acquired by the function object acquiring unit 15 for the received access token. For example, if the result of the verification of the access token concerning the request received by the request receiving unit 12 is failure, the request processing unit 17 may not accept the processing concerning the request and may supply an error to the processed data providing unit 18. If the result of the verification of the access token concerning the request received by the request receiving unit 12 is success, the request processing unit 17 processes the request received by the request receiving unit 12 on the basis of the function object acquired by the function object acquiring unit 15 for the access token received for the request and supplies the result of the processing to the processed data providing unit 18.

The processed data providing unit 18 provides the result of the processing in the request processing unit 17 to the user terminal 5, which has submitted the request.

### [3. Description of Exemplary Processes]

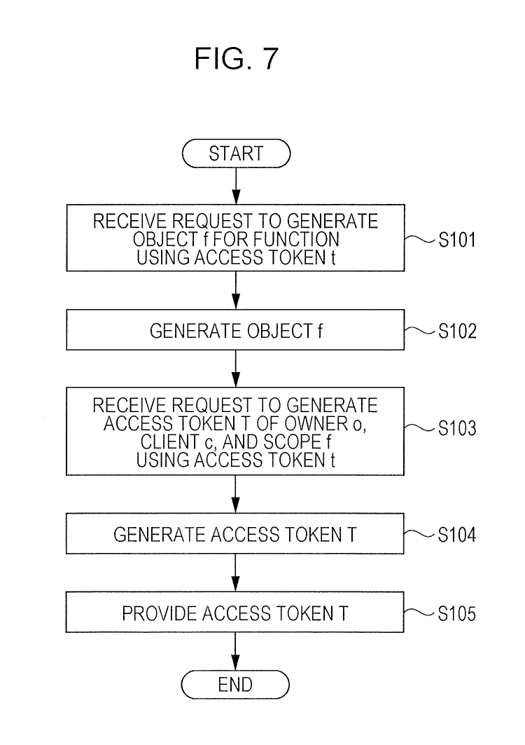

Exemplary processes executed in the information processing system S will now be described in detail with reference to flowcharts illustrated in FIG. 7 to FIG. 10.

### [3.1 Process of Generating Token]

FIG. 7 is a flowchart illustrating an exemplary process of generating the access token executed by the information managing apparatus 10. It is assumed in the flowchart in FIG. 7 that an access token t exists and the access token t has a scope with which an object is capable of being generated, acquired, updated, and deleted.

Referring to FIG. 7, in Step S101, the information managing apparatus 10 receives a request to generate an object (function data object) f having the source code of a desired function as the value using the access token t from, for example, the user terminal 5. In Step S102, the information managing apparatus 10 generates the object f. The information managing apparatus 10 may indicate the identification information (ID) of the object f generated in Step S102 to the user terminal 5.

In Step S103, the information managing apparatus 10 receives a request to generate an access token T including an owner o, a client c, and a scope f (the identification information about the object f) using the access token t from, for example, the user terminal 5. In Step S104, the information managing apparatus 10 generates the access token T. In Step S105, the information managing apparatus 10 provides the information about the access token T generated in Step S104 (the ID of the access token T) to, for example, user terminal 5. Then, the process in FIG. 7 is terminated.

### [3.2 Process for Request]

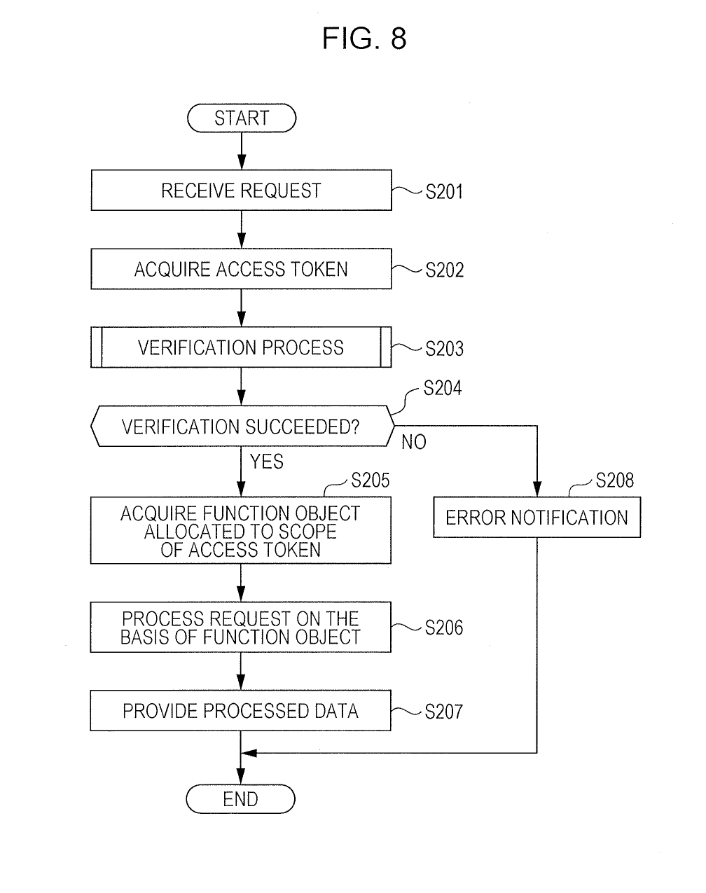

FIG. 8 is a flowchart illustrating an exemplary process for a request using the access token T, executed by the information managing apparatus 10.

### [3.2.1 Process for Request (S201 to S203)]

Referring to FIG. 8, in Step S201, the information managing apparatus 10 receives a request from, for example, the user terminal 5. In Step S202, the information managing apparatus 10 acquires the access token concerning the request (the access token T here). For example, the information managing apparatus 10 may acquire the object ID of the access token from the Authorization field in the HTTP request from the user terminal 5 or may acquire the object ID of the access token from any cookie including the information about the access token.

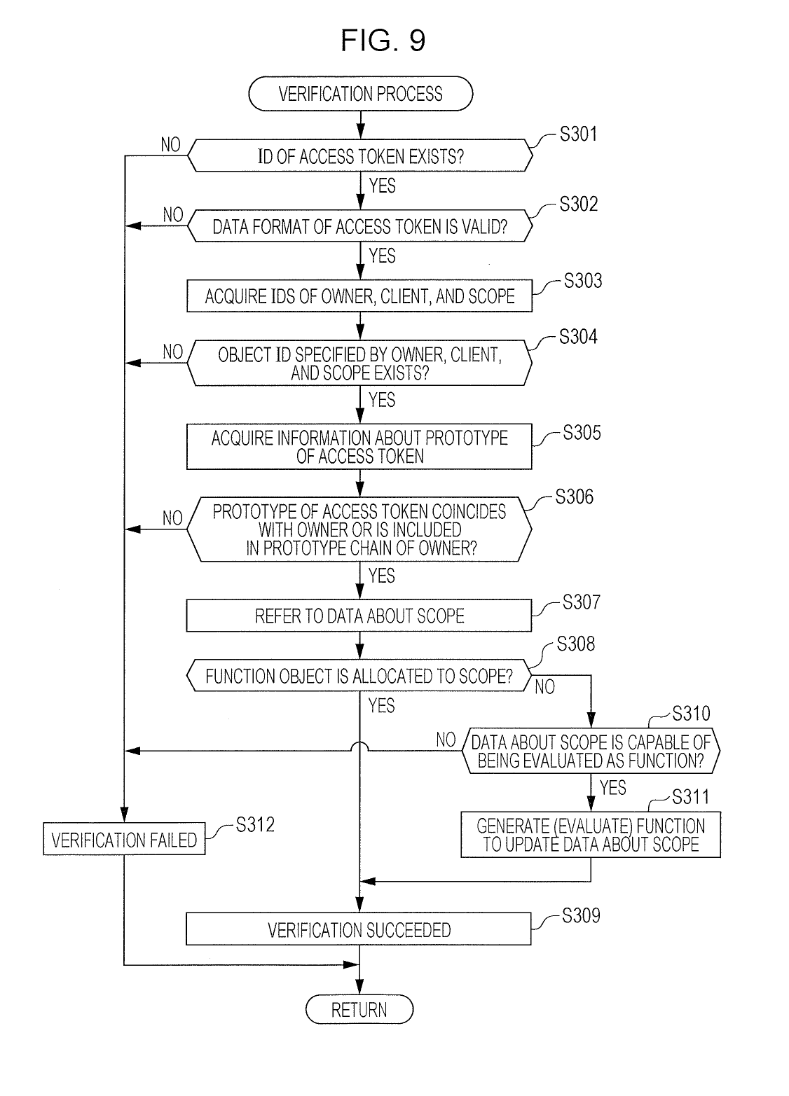

In Step S203, the information managing apparatus 10 executes a verification process based on the access token acquired in Step S202. The verification process based on the access token will be described in detail below with reference to a flowchart illustrated in FIG. 9.

### [3.2.2 Verification Process of Access Token]

FIG. 9 is a flowchart illustrating an exemplary verification process of the access token. Referring to FIG. 9, in Step S301, the information managing apparatus 10 determines whether the ID of the access token to be verified exists in the IDs managed by the object information managing unit 11. For example, the information managing apparatus 10 may perform the above determination based on whether the ID of the access token to be verified is included in the object IDs in the prototype-based object management table managed by the object information managing unit 11. If the ID of the access token to be verified exists in the IDs managed by the object information managing unit 11 (YES in Step S301), the process goes to Step S302. If the ID of the access token to be verified does not exist in the IDs managed by the object information managing unit 11 (NO in Step S301), in Step S312, the information managing apparatus 10 determines that the verification failed. Then, the process returns to the process illustrated in FIG. 8.

If the ID of the access token to be verified exists in the IDs managed by the object information managing unit 11 (YES in Step S301), in Step S302, the information managing apparatus 10 refers to the data about the access token using the ID of the access token as a key to determine whether the data format of the access token is valid. For example, the information managing apparatus 10 may determine that the data format of the access token is valid if the type attribute set in the access token is application/json and otherwise may determine that the data format of the access token is not valid. If the data format of the access token is valid (YES in Step S302), the process goes to Step S303. If the data format of the access token is not valid (NO in Step S302), in Step S312, the information managing apparatus 10 determines that the verification failed. Then, the process returns to the process illustrated in FIG. 8.

If the data format of the access token is valid (YES in Step S302), in Step S303, the information managing apparatus 10 acquires the values (IDs) of the owner, the client, and the scope specified for the access token. In Step S304, the information managing apparatus 10 determines whether the object ID specified by the owner, the client, and the scope exists in the IDs managed by the object information managing unit 11. For example, the information managing apparatus 10 may perform the above determination based on whether the object ID specified by the owner, the client, and the scope is included in either of the prototype-based object management table and the data object management table. If the object ID of the owner, the client, and the scope specified for the access token is included in the IDs managed by the object information managing unit 11 (YES in Step S304), the process goes to Step S305. If the object ID of the owner, the client, and the scope specified for the access token is not included in the IDs managed by the object information managing unit 11 (NO in Step S304), in Step S312, the information managing apparatus 10 determines that the verification failed. Then, the process returns to the process illustrated in FIG. 8.

If the object ID of the owner, the client, and the scope specified for the access token is included in the IDs managed by the object information managing unit 11 (YES in Step S304), in Step S305, the information managing apparatus 10 acquires the information about the prototype (the object ID of the parent object) of the access token. In Step S306, the information managing apparatus 10 determines whether the prototype object of the access token coincides with the owner specified for the access token or is included in the prototype chain of the owner (the path in which ancestor objects of the owner are sequentially connected). If the information managing apparatus 10 determines that the prototype object of the access token is included in the prototype chain of the owner (YES in Step S306), the process goes to Step S307. If the information managing apparatus 10 determines that the prototype object of the access token is not included in the prototype chain of the owner (NO in Step S306), in Step S312, the information managing apparatus 10 determines that the verification failed. Then, the process returns to the process illustrated in FIG. 8.

If the prototype object of the access token coincides with the owner specified for the access token or is included in the prototype chain of the owner (YES in Step S306), in Step S307, the information managing apparatus 10 refers to the data about the object ID of the scope specified for the access token. For example, the information managing apparatus 10 may refer to the information about the records stored in the data object management table using the object ID of the scope as a key.

In Step S308, the information managing apparatus 10 determines whether the function object is allocated to the data about the scope referred to in Step S307. For example, the information managing apparatus 10 may perform the above determination based on whether the identification information is stored in the func attribute in the data about the scope. If the function object is allocated to the data about the scope (YES in Step S308), in Step S309, the information managing apparatus 10 determines that the verification succeeded. Then, the process returns to the process illustrated in FIG. 8. If the function object is not allocated to the data about the scope (NO in Step S308), in Step S310, the information managing apparatus 10 determines whether the source code included in the data about the scope is capable of being evaluated as the function. If the source code included in the data about the scope is capable of being evaluated as the function (YES in Step S310), in Step S311, the information managing apparatus 10 generates the function object on the basis of the source code and stores the ID of the generated function object in the func attribute of the scope to update the data about the scope. In Step S309, the information managing apparatus 10 determines that the verification succeeded. Then, the process returns to the process illustrated in FIG. 8. If the source code included in the data about the scope is not capable of being evaluated as the function (NO in Step S310), in Step S312, the information managing apparatus 10 determines that the verification failed. Then, the process returns to the process illustrated in FIG. 8.

The verification process based on the access token is performed in the above manner. The description returns to the flowchart in FIG. 8.

### [3.2.3 Process for Request (Step S204 to S208)]

Referring back to FIG. 8, after the verification process of the access token is finished in Step S203, in Step S204, the information managing apparatus 10 determines whether the result of the verification of the access token is success. If the result of the verification of the access token is success (YES in Step S204), in Step S205, the information managing apparatus 10 acquires the function object allocated to the scope of the access token. For example, the information managing apparatus 10 may acquire the function object identified by the identification information stored in the func attribute in the data about the scope of the access token.

In Step S206, the information managing apparatus 10 processes the request received in Step S201 on the basis of the function object associated with the access token acquired in Step S205. In Step S207, the information managing apparatus 10 provides the processed data resulting from the processing in Step S206 to the user terminal 5, which has submitted the request, as a response to the request. Then, the process in FIG. 8 is terminated.

If the result of the verification of the access token is failure (NO in Step S204), in Step S208, the information managing apparatus 10 returns an error to the user terminal 5, which has submitted the request. Then, the process in FIG. 8 is terminated. The information managing apparatus 10 may notify the user terminal 5 of an error code corresponding to the content (cause) of the failure of the verification.

According to the information managing apparatus 10 described above, it is possible to associate arbitrary server-side processing with the access token. Accordingly, varying the value of the scope associated with the access token for one end point allows the processing to be executed to be switched.

### [3.3 Specific Example of Process for Request]

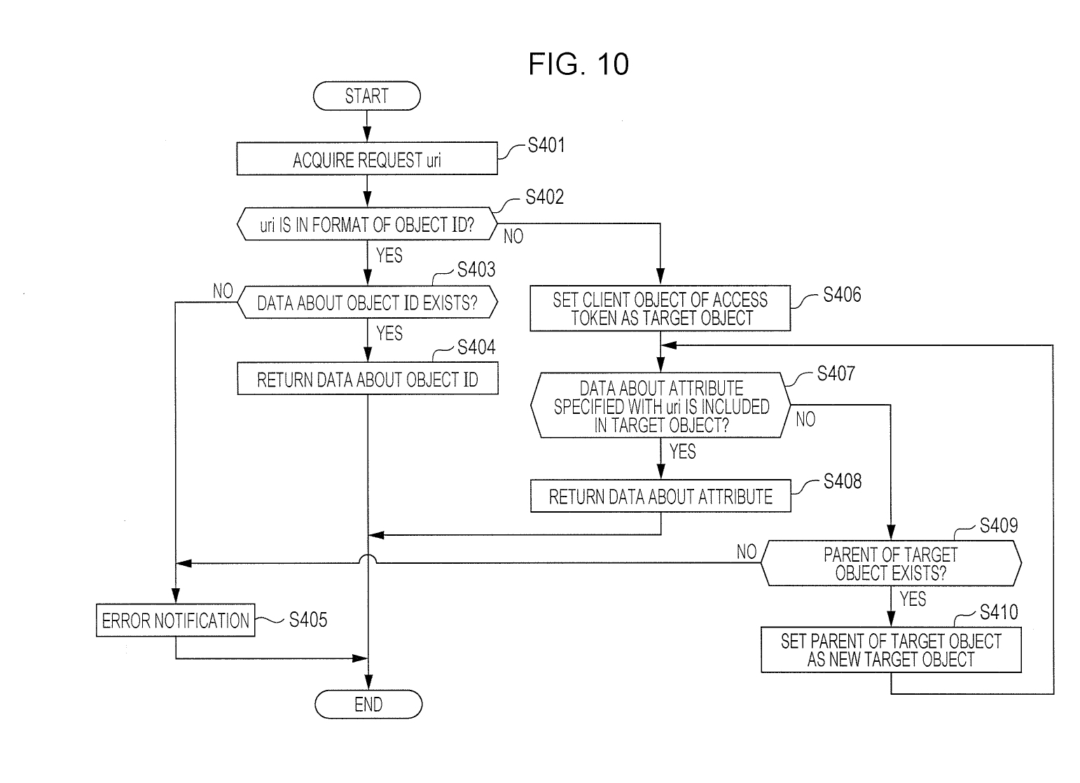

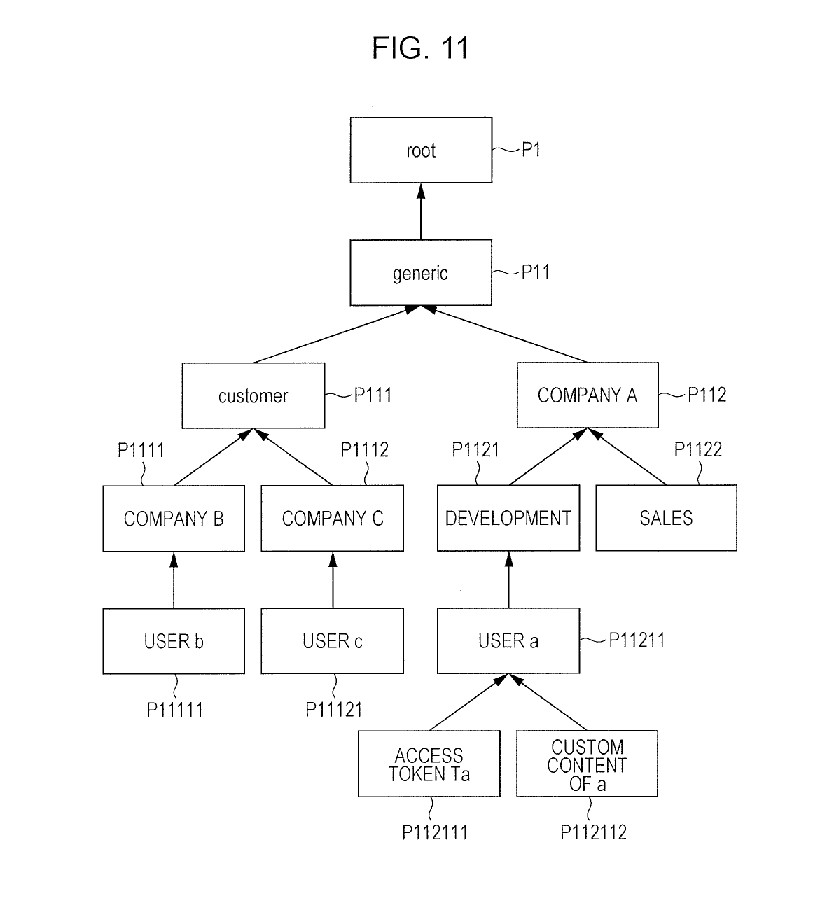

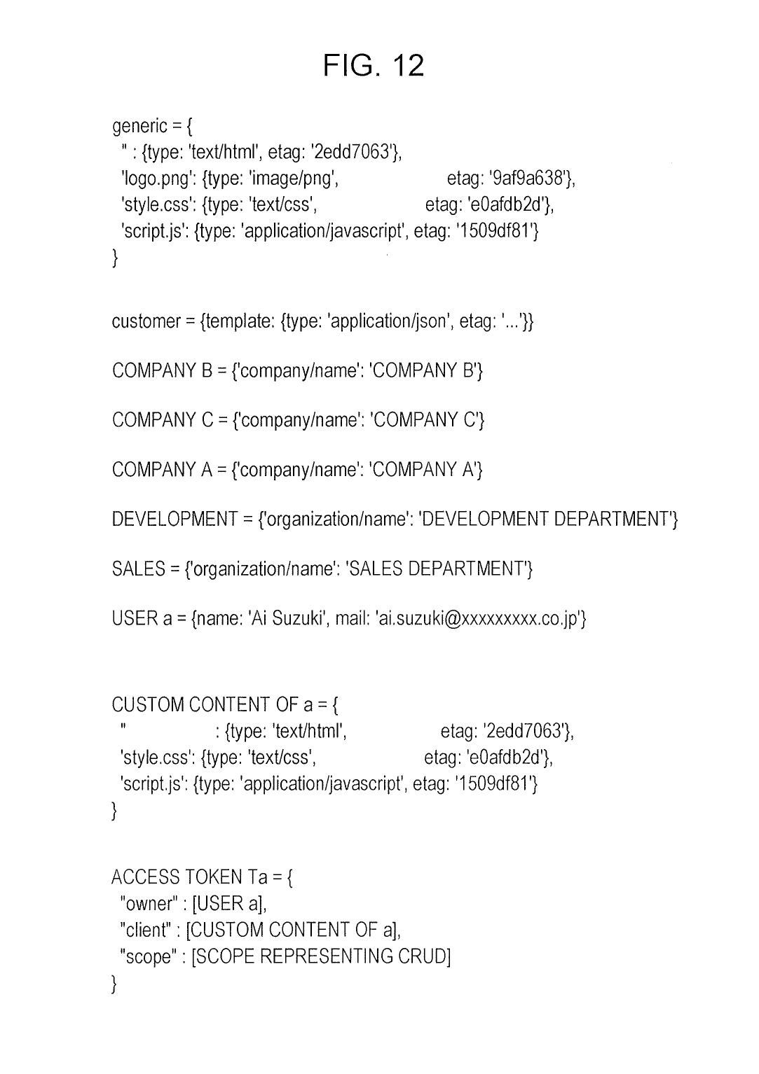

An exemplary process for a request executed in the information managing apparatus 10 will be described with reference to a flowchart illustrated in FIG. 10 and exemplary structures of the objects illustrated in FIG. 11 and FIG. 12. It is assumed in the examples described below that data having the elements composing content (for example, a Web page) to be provided to the user terminal 5 and the values of the elements as the attributes and the attribute values is added to the prototype-based object. Exemplary structures of the objects will now be described with reference to FIG. 11 and FIG. 12.

FIG. 11 illustrates an exemplary tree structure of the prototype-based objects. Referring to FIG. 11, a “root” object P1 is the root object and a “generic” object P11 is an object having the “root” object P1 as the prototype. A “customer” object P111 and a “COMPANY A” object P112 are objects having the “generic” object P11 as the prototype. A “COMPANY B” object P1111 and a “COMPANY C” object P1112 are objects having the “customer” object P111 as the prototype. A “DEVELOPMENT” object P1121 and a “SALES” object P1122 are objects having the “COMPANY A” object P112 as the prototype. A “USER a” object P11211 is an object having the “DEVELOPMENT” object P1121 as the prototype. An “ACCESS TOKEN Ta” object P112111 and a “CUSTOM CONTENT OF a” object P112112 are objects having the “USER a” object P11211 as the prototype.

FIG. 12 illustrates exemplary pieces of data added to the objects illustrated in FIG. 11 as the attributes. Each piece of object data includes one or more pairs of ‘attribute’ and ‘attribute value’.

An exemplary process of reading out data concerning the request from the prototype-based object to respond to the request will now be described with reference to the flowchart illustrated in FIG. 10. It is assumed in the example illustrated in FIG. 10 that the function with which reading (read) of the data about the object is permitted is associated with the access token concerning the request received from the user terminal 5 by the information managing apparatus 10.

Referring to FIG. 10, in Step S401, the information managing apparatus 10 acquires uri, which a request URI, from, for example, the user terminal 5. In Step S402, the information managing apparatus 10 determines whether uri is in the format of the object ID. If uri is in the format of the object ID (YES in Step S402), in Step S403, the information managing apparatus 10 determines whether data about the object ID specified with uri exists. If data about the object ID specified with uri exists (YES in Step S403), in Step S404, the information managing apparatus 10 reads out the data to return the data as the response to the request. Then, the process in FIG. 10 is terminated. If data about the object ID specified with uri does not exist (NO in Step S403), in Step S405, the information managing apparatus 10 notifies the user terminal 5 of the error. Then, the process in FIG. 10 is terminated.

If uri acquired in Step S401 is not in the format of the object ID (NO in Step S402), in Step S406, the information managing apparatus 10 determines that the attribute name is specified for uri and sets the object specified by the information about the client of the access token concerning the request received from the user terminal 5 as a target object.

In Step S407, the information managing apparatus 10 determines whether the attribute specified with uri is included in the data added to the target object. If the attribute specified with uri is included in the data added to the target object (YES in Step S407), in Step S408, the information managing apparatus 10 returns the data added to the target object as the attribute value of the attribute concerning the request. Then, the process in FIG. 10 is terminated.

If the attribute specified with uri is not included in the data added to the target object (NO in Step S407), in Step S409, the information managing apparatus 10 determines whether the parent (that is, prototype) object of the current target object exists. If the parent (that is, prototype) object of the current target object exists (YES in Step S409), in Step S410, the information managing apparatus 10 sets the parent of the current target object as a new target object. Then, the process goes back to Step S407. If the parent (that is, prototype) object of the current target object does not exist (NO in Step S409), in Step S405, the information managing apparatus 10 determines that the corresponding data does not exist and notifies the user terminal 5 of the error. Then, the process in FIG. 10 is terminated.

While the invention is described in terms of some specific exemplary examples and embodiments, it will be clear that this invention is not limited to the specific examples of the structure and the configuration and the example of how to store the data and that many changes and modified exemplary embodiments will be obvious to those skilled in the art without departing from the true spirit and scope of the invention. For example, the data structure and the processing order may be modified. For example, although the example in which the identification information about the function data object is specified for the scope of the access token is described in the above exemplary embodiments, the function (command) itself may be fixed to the scope.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing system comprising:
a managing unit that manages objects for each of which at least one of a parent and a child is defined, an element name and an element value of an element composing content being associated with at least part of the objects in the managing unit;
a receiving unit that receives a request for a process including specification of an authorized object with which authority information is associated;
a setting unit that sets a target object on a basis of the authorized object and, if the element name specified in the request is not associated with the target object, repeats a process of setting a parent object of the target object as a new target object until a predetermined condition is met; and
a responding unit that, if the element name specified in the request is associated with the target object set by the setting unit, returns the element value associated with the target object as a response to the request.

2. The information processing system according to claim 1,
wherein the setting unit repeats the setting of the target object until the target object with which the element name specified in the request is associated is found or no parent object of the target object exists.

3. The information processing system according to claim 1,
wherein, if the request specifies an object, the responding unit returns data associated with the object specified in the request, and
wherein, if the request specifies no object, the responding unit determines that the request specifies an element name and sets the target object with the setting unit.

4. The information processing system according to claim 2,
wherein, if the request specifies an object, the responding unit returns data associated with the object specified in the request, and
wherein, if the request specifies no object, the responding unit determines that the request specifies an element name and sets the target object with the setting unit.

5. The information processing system according to claim 1, further comprising:
a determining unit that determines whether the request is accepted on a basis of a result of comparison between information about an owner object that grants the authority information with information about a parent object of the authorized object,
wherein, if the request is accepted, the responding unit returns the response to the request.

6. The information processing system according to claim 5,
wherein, if the owner object coincides with the parent object of the authorized object, the determining unit accepts the request.

7. The information processing system according to claim 5,
wherein, if the parent object of the authorized object is included in a path in which the parent object of the owner object is sequentially connected to the parent object of the parent object of the owner object, the determining unit accepts the request.

8. The information processing system according to claim 5,
wherein, if the authorized object is not managed by the managing unit, the determination unit does not accept the request.

9. A non-transitory computer readable medium storing a program causing a computer to execute a process comprising:
managing objects for each of which at least one of a parent and a child is defined, an element name and an element value of an element composing content being associated with at least part of the objects in the managing;
receiving a request for a process including specification of an authorized object with which authority information is associated;
setting a target object on a basis of the authorized object and, if the element name specified in the request is not associated with the target object, repeating a process of setting a parent object of the target object as a new target object until a predetermined condition is met; and
returning, if the element name specified in the request is associated with the target object that is set, the element value associated with the target object as a response to the request.

10. An information processing method comprising:
managing objects for each of which at least one of a parent and a child is defined, an element name and an element value of an element composing content being associated with at least part of the objects in the managing;
receiving a request for a process including specification of an authorized object with which authority information is associated;
setting a target object on a basis of the authorized object and, if the element name specified in the request is not associated with the target object, repeating a process of setting a parent object of the target object as a new target object until a predetermined condition is met; and
returning, if the element name specified in the request is associated with the target object that is set, the element value associated with the target object as a response to the request.
